(19) United States
(12) Patent Application Publication
(10) Pub. No.: US 2005/0107162 A1
(43) Pub. Date: May 19, 2005

(54) Method and system for implementing a game

(76) Inventors: Barry Charles Kilby, Preston (GB); Andrew Patrick Gray, Halifax (GB)

Correspondence Address: KENYON & KENYON, One Broadway, New York, NY, 10004, US

(21) Appl. No.: 10/692,052

(22) Filed: Oct. 22, 2003

Related U.S. Application Data
(63) Continuation of application No. 09/575,501, filed on May 19, 2000, now abandoned.

(51) Int. Cl. A63F 13/00

(52) U.S. Cl. 463/42; 463/17

(57) ABSTRACT

A system and method for implementing a game played by a game participant includes a ticket having a security feature and a server operating a game site including a game image. A game participant computer is capable of accessing the game site over a network, the game participant entering the security feature at the game participant computer to play the game, including locating a winning object in the game image using the game participant computer.

### TECHNICAL FIELD

This invention relates to a method and system for implementing a game, particularly a game of chance and/or skill played for a prize.

### BACKGROUND

Games of chance and/or skill include lottery-type games for which prizes are awarded to winning game participants. These games typically involve multiple game participants who play singly on the basis of predetermined odds or against other participants in an attempt to win a prize.

Lottery-type generally fall into two categories, namely instant games and interval games. Instant games are, e.g., games in which game participants remove portions of a removable, opaque coating such as a latex coating from a scratch ticket based on a predetermined set of rules. Instant games allow game participants to determine immediately whether or not they have won a prize. Interval games are, e.g., lottery games involving daily or weekly drawings in which winning game elements are selected from a larger set of game elements, such as numbers or symbols, the game participants having previously selected sets of game elements which they believe the winning game elements will match. In interval games, there is a delay before game participants are notified of the winning game elements and whether or not they are winners, and prizes typically accumulate in games over successive intervals until there is a winner.

Lottery-type games have been implemented using media such as television, radio, newspapers, magazines and pre-printed gaming tickets. The use of such media for lottery-type games is limited in that the games fail to combine the interactive nature of instant game scratch tickets with the anticipation and potentially large prizes available for interval games.

One game played via newspapers is known as “spot the ball.” In such a game, game participants are provided with a photograph having a missing element or object, such as a picture of a sporting event such as a soccer game from which the ball has been removed. Based on the positions of the sporting event players and other clues in the picture, the game participants attempt, using skill and judgment, to guess the location in the photograph where the ball should be. To enter the game, the game participants mark their selected location of the ball in the photograph with an “X” and send the marked photograph to the organizer of the competition. Upon collecting the returned photographs, the competition organizer determines which game participant has most accurately or closely identified the correct location of the missing ball in the photograph to receive a prize.

### SUMMARY

In general, in one aspect, the invention features a system for implementing a game played by a game participant. A ticket has a security feature. A server operates a game site including a game image. A game participant computer is capable of accessing the game site over a network, the game participant entering the security feature at the-game participant computer to play the game, including locating a winning object in the game image using the game participant computer.

Implementations of the invention may also include one or more of the following features. The game participant computer may include a mouse for locating the winning object in the game image. The game image may include a coordinate system for determining the location of the winning object.

The system may include an on-line point-of-sale terminal for generating the ticket. The on-line point-of-sale terminal may be capable of communicating with the server. The network may be the Internet. The ticket may be a scratch ticket.

In general, in another aspect, the invention features a method of implementing a game. A game site is provided for playing the game. A game image and a coordinate system to define a location of a winning object in the game image are generated. A selection of a location of the winning object in the game image is accepted. A prize is awarded based on the selection of the location of the winning object compared to a correct location of the winning object in the game image.

Implementations of the invention may also include one or more of the following features. A security feature may be provided for accessing the game site. A ticket containing the security feature may be provided. The winning object may be absent from the game image.

The method may include generating a pointer in the game image and tracking a movement of the pointer in the game image based on a location of the pointer as defined by the coordinate system. The method may also include accepting the selection for the location of the winning object based on the location of the pointer in the game image. The method may further include displaying the pointer in the shape of the winning object.

The method may include providing a clue to suggesting the location of the winning object. The clue may be provided in the game image.

A plurality of selections for the location of the winning object may be accepted. The prize may be awarded based on one of the plurality of possible sections determined to be closest to the correct location of the winning object.

In general, in another aspect, the invention features a method of implementing a game played by a game participant. A game site for playing the game is provided, the game site being accessible to the game participant over a network. A security feature input at the game site is validated, the security feature being provided to the game participant to play the game and to prevent an unauthorized access to the game site. The game is generated upon validation of the security feature.

Implementations of the method may also include one or more of the following features. An on-line point-of-sale terminal may be provided for generating a ticket. The ticket may contain the security feature.

In general, in another aspect, the invention features a system for implementing a game played by a game participant. A ticket has a security feature. A server operates a game site including a game image. A game participant computer is capable of accessing the game site over a network, the game participant entering the security feature at the game participant computer to play the game.

Implementations of the invention may also include the following feature. The system may include an on-line point-of-sale terminal for generating the ticket.

In general, in another aspect, the invention features an apparatus including a computer-readable medium that stores instructions for implementing a game played by a game participant, the instructions for causing a computer to provide a game site for playing the game, generate a game image on the game site and a coordinate system to define a location of a winning object in the game image, accept a selection of a location of the winning object in the game image, and award a prize based on the selection of the location of the winning object compared to a correct location of the winning object in the game image.

Implementations of the invention may also include the following feature. The apparatus may include instructions for causing a computer to provide a security feature for accessing the game site.

In general, in another aspect, the invention features a system for implementing a game played by a game participant. A memory stores computer instructions. A processor executes the computer instructions to provide a game site for playing the game, generate a game image on the game site and a coordinate system to define a location of a winning object in the game image, accept a selection of a location of the winning object in the game image, and award a prize based on the selection of the location of the winning object compared to a correct location of the winning object in the game image.

Implementations of the invention may also include the following feature. The system may include instructions to provide a security feature for accessing the game site.

In general, in another aspect, the invention features an apparatus comprising a computer-readable medium that stores instructions for implementing a game played by a game participant, the instructions for causing a computer to provide a game site for playing the game, the game site being accessible to the game participant over a network, validate a security feature input at the game site, the security feature being provided to the game participant to play the game and to prevent an unauthorized access to the game site, and generate the game upon validation of the security feature.

Implementations of the invention may also include the following feature. The apparatus may include instructions for causing a computer to generate a ticket for providing the security feature.

In general, in another aspect, the invention features a system for implementing a game played by a game participant. A memory stores computer instructions. A processor executes the computer instructions to provide a game site for playing the game, the game site being accessible to the game participant over a network, validate a security feature input at the game site, the security feature being provided to the game participant to play the game and to prevent an unauthorized access to the game site, and generate the game upon validation of the security feature.

Implementations of the invention may also include the following feature. The system may include an on-line point-of-sale terminal for generating a ticket, the ticket containing the security feature.

An advantage of the present invention is that game participants are provided with an entertaining way to win prizes using a network such as the Internet combined with traditional lottery or promotional channels.

Another advantage of the present invention is that the game may have a theme, such as a sporting-event theme, that taps into the game participants' enthusiasm for activities associated with the theme.

A further advantage of the present invention is that game participants use skill and judgment to place game entries.

The details of embodiments of the invention are set forth in the accompanying drawings and the description below. Other features, objects, and advantages of the invention will be apparent from the description and drawings, and from the claims.

### DESCRIPTION OF DRAWINGS

FIG. 1 shows a game page of a game site for playing the game of the present invention.

FIG. 2 is a diagrammatic sketch of a system for playing the game of the present invention.

FIG. 3 shows a home page for playing the game of FIG. 1.

FIG. 4 shows an updated view of the game page of FIG. 1.

FIG. 5A illustrates a ticket for providing security features to participants of the game shown in FIG. 1.

FIG. 5B shows a ticket generated by an on-line point-of-sale terminal.

FIG. 6 shows another updated view of the game page of FIG. 4.

FIG. 7 shows another updated view of the game page of FIG. 6.

FIG. 8 shows an exit page for the game of FIG. 1.

FIG. 9 shows an award page for the game of FIG. 1.

FIG. 10 is a flow diagram showing a method of implementing the game of the present invention.

Like reference symbols in the various drawings indicate like elements.

### DETAILED DESCRIPTION

The present invention relates to a method and system for implementing a game in which game participants play or compete for a prize. The game involves selecting a particular object, i.e., a “winning object”, or the location of the winning object in a game image such as a photograph, the correct identity or location of the winning object being concealed from the game participants. The method and system for implementing the game involves providing game participants with a game site accessible over a network at which the game participants are authorized to play the game. Such a system allows a plurality of game participants to compete in an interactive game for a prize.

In a preferred embodiment, the game involves a photograph of a sporting event such as a soccer game from which the ball has been removed, the winning object being the missing soccer ball. Additional embodiments of the game may include other sporting events using balls or similar objects, such as football, baseball, hockey, golf and tennis events.

A system for playing the game of the present invention includes three components: (1) a gaming ticket received by a game participant promotionally or through purchase by the game participant, (2) a game site on a network accessible to the game participant for placing an entry to play the game, and (3) a medium for announcing winning results so that the game participant may determine whether or not he or she has placed a winning game entry. The ticket allows the game participant to access the game site on line from a computer or workstation capable of communicating over the network. By possessing the ticket, the game participant is permitted to place a predetermined number of entries in a particular period, e.g., one entry containing five chances for playing the game on a particular day.

In particular, the game consists of trying to determine the exact position of a winning object on a game image displayed at the game site. This is done by moving a pointer around the game image, e.g., using the “click-drag-and-drop” function of the mouse attached to the game participant's computer, until the game participant is satisfied with his or her selections for the location of a winning object.

The game participant deduces his or her game entries based on evidence or clues in the game image, such as the body language and facial expressions of players and spectators in a sporting event, and places the entries on line using, e.g., the “click-drag-and-drop” function of the mouse.

Preferably, a grid reference or a pair of coordinates associated with the exact center of the pointer is shown to the game participant as he or she moves the winning object around the image. The game site uses a coordinate system or grid that underlies and is directly translated to the pixel field of the photographic image. As a result, the number of pixels in the picture may determine the fineness of the grid, and thus determine the probability of placing a winning game entry.

After selecting a location or locations for the winning object, the game participant's entries, e.g., in the form of coordinate pairs, are accepted and registered. At a specified later time, the winning coordinates, i.e., grid references, preferably along with the image showing the correct location of the winning object, are published so that the game participant may determine whether or not he or she is a winner to obtain a prize, e.g., by redeeming the ticket. Alternately, winning game participants may be notified automatically, e.g., by e-mail. The game participant may also obtain the winning location or coordinates for the winning object by accessing the game site over the network or through normal lottery channels such as a receipt printed by an on-line point-of-sale terminal at a retail location or other media such as newspapers, radio or television. Winning game participants may then claim prizes from the retail location or directly from the gaming authority administering the game.

Thus, the game of the present invention is an interactive game of chance and skill played over a network. This arrangement allows game participants to view and examine their selections, e.g., using the mouse click-drag-and-drop function, to pinpoint an exact location of the winning object on the game image before submitting their game entries. In particular, by using a digital picture as the game image, a game participant can point to precise pixels of an image to be confident that he or she has placed accurate game entry.

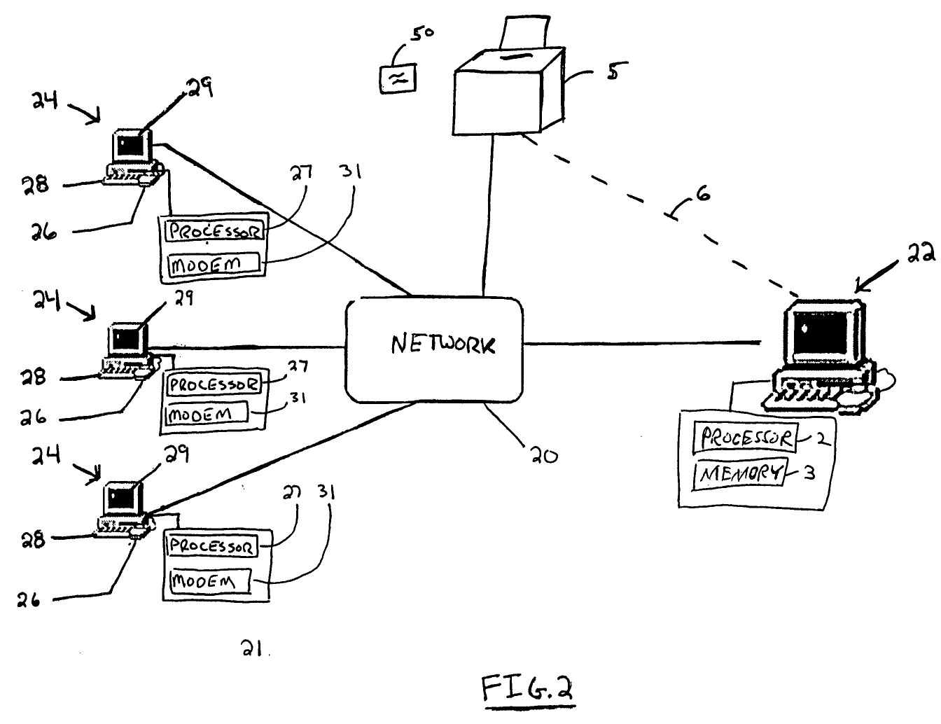

FIG. 2 shows a system 21 for playing the game of the present invention. Server 22 is a network-based computer that communicates with game participant computers 24 over a network 20. On-line point-of-sale terminal 5 for producing game tickets such as ticket 50 may also communicate with server 22, either via network 20 or through a separate, secure link 6.

Game server 22 operates game site 10, which is accessed using game participant computers 24 by sending and receiving signals for generating game pages to display game image 12 and other aspects and features of the game. Game server 22 also preferably stores, maintains and updates game information to keep track of game entries made by game participants.

Game server 22 preferably includes a processor 2 and a memory 3. Memory 3 is a computer-readable medium that stores, e.g., instructions for causing a computer or processor to implement the game. Processor 2 is capable of executing the instructions to implement the game.

Game participant computers 24 have a mouse 26, a processor 27, a keyboard 28, a modem 31 or other device for communicating over a network, and a monitor 29. Mouse 26, keyboard 28 and monitor 29 function as input/output devices for sending and receiving signals between the game participant and game site 10. In further embodiments, game participant computers 24 may include other types of input/output devices, e.g., touch-sensitive screens, speakers, cameras, and microphones.

Network 20 may be any type of network such as the Internet or a public or private internet, intranet or dial-up electronic network. Communications over network 20 are preferably secure, e.g., using encryption techniques. In an embodiment in which the network 20 is the Internet, game site 10 is preferably implemented as a web site using HTTP protocol.

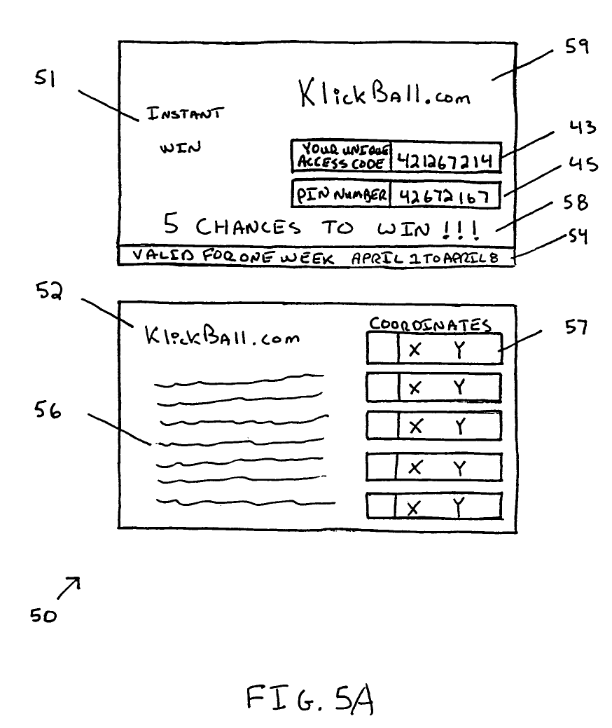

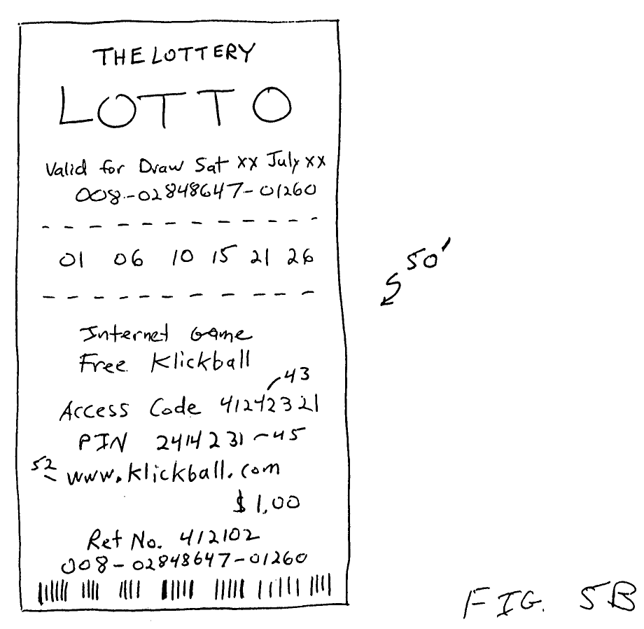

FIG. 5A shows a ticket 50 for playing the game of the present invention. Ticket 50 is a substrate having a front surface 51 and back surface 52. Ticket front 51 includes security features in the form of a unique access code 43 and a security number 45, such as a personal identification number (PIN), which allow a game participant to play the game and register one or more game entries at the game site. Ticket back 52 has instructions 56 and coordinate region 57. Instructions 56 may contain directions for accessing game site 10. Coordinate regions 57 serve as an area to record information regarding play of the game. Both ticket front 51 and back 52 may also contain additional information, such as ticket expiration information 54 indicating a valid time frame which the ticket may be played 50; a number of purchased chances 58 indicating the number of entries a game participant has purchased for a particular game; and various promotional titles 59 for generating excitement and interest in the particular game. Alternatively, the game ticket may be printed on any substrate, including on a single side of the substrate.

A game participant may purchase ticket 50 from an authorized lottery retailer or agent. The ticket may otherwise be provided to a game participant, e.g., in promotional materials such as a newspaper or a retail handout, or accompanying a consumer product or service being promoted, e.g., charitable organizations looking to raise finds or sports teams attempting to increase interest in their events. Alternatively, the game participant may obtain the ticket on-line over network 20.

Since ticket 50 may be purchased separately from play of the game over a network, the monetary security of the purchased game entry is assured, i.e., no credit card number need be transmitted over an unsecured network to play the game. Moreover, for a promotional game, the ticket may link the game played over the network with a product such as a commercially available consumer product.

Ticket 50 may be pre-printed, e.g., in the form of a scratch ticket for which security information to access the game over network 20 is covered by a removable, opaque coating until the game participant removes the coating to reveal the information. As an alternative, the security information may be covered using other methods of concealment, or the security information may not be concealed at all. Alternatively, ticket 50, which has the security information needed to access the game over network 20, may be generated using on-line point-of-sale terminal 5 in communication with server 22. FIG. 5B is an example of such a ticket 50′ generated by an 6n-line point-of-sale terminal. Such an on-line point-of-sale terminal may be located at a retail location for the convenience of game participants. There may be multiple point-of-sale terminals at retail locations capable of generating such tickets, all of the terminals communicating with server 22 over network 20 or via another secure communications link or network, e.g., link 6.

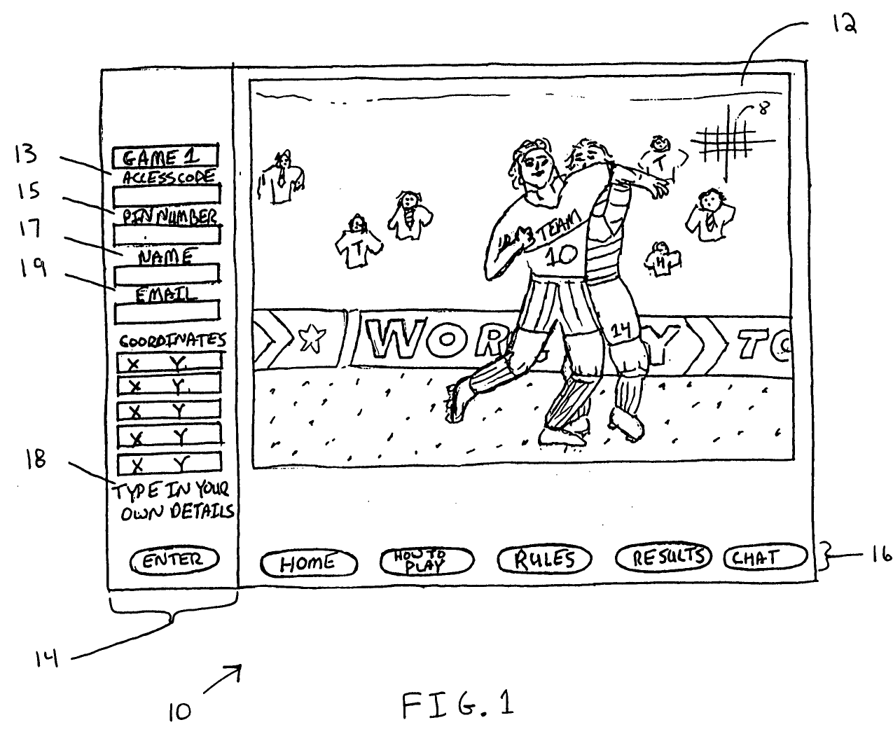

As shown in FIG. 1, server 22 operates a game site 10 which includes a game page having a game image 12, a player information region 14 and a game menu 16. In the example of FIG. 1, game image 12 is a photograph of a soccer game for a game called Klickball™. However, game image 12 may be any image or picture for which a wager game may be created or for which prizes or other incentives are awarded to game participants determined to be winner based on a set of game rules. For example, in Klickball™, game participants attempt to select the exact location of a missing soccer ball from the photograph, which overlies a two-dimensional coordinate system 8.

Player information region 14 of game site 10 is a location on the game page for the 30 game participant to enter unique personal information to play the game. Such player information may include, e.g., security access code 13, PIN 15, game participant name 17, and e-mail address 19. Player information region 14 may be customized to the particular game being played on game site 10. Player information region 14 also includes game site instruction 18 to assist the game participant in playing the game and correctly placing game entries. For example, as shown in FIG. 1, game site instruction 18 requests the game participant to enter his or her unique details to begin the game.

Game site 10 may also include a game menu 16 to facilitate movement between related display pages of game site 10. The game menu may be customized to the particular game being played.

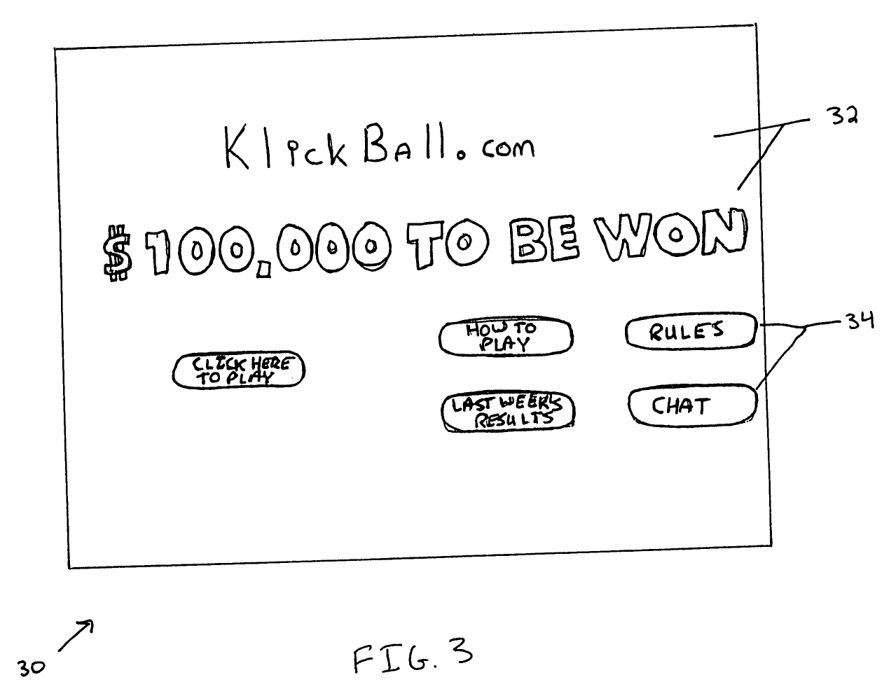

As shown in FIG. 3, a game participant accesses game site 10 via a home page 30. Home page 30 directs game participants and other visitors to the game site to information relating to the particular game being played on game site 10. Home page 30 may also display advertising 32, e.g., for promoting game site 10 and possibly other products and services. Home page 30 may also display links 34 to related pages, e.g., rules, chat, results, etc., for various information and activities associated with game site 10. For example, the “click here to play” link directs game participants to the page containing game image 12 (FIG. 1). In other embodiments, home page 30 may provide links to game sites for other types of wagering games.

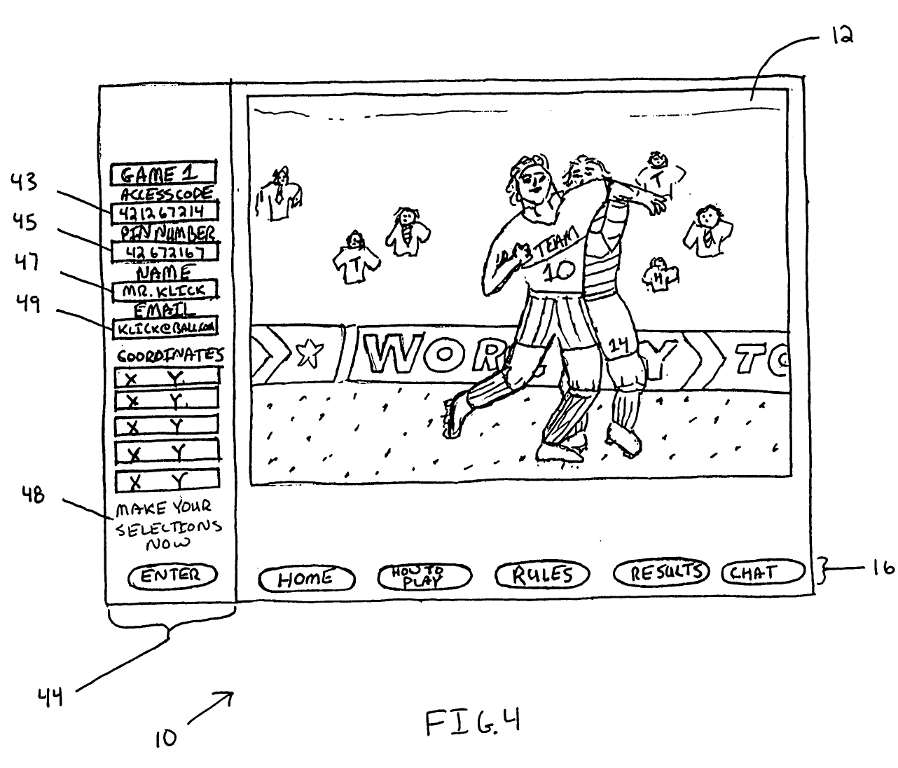

FIG. 4 shows game site 10 with updated player information region 44, i.e., region 14 containing the game participant's personal information as requested by player instruction 18. In the example of FIG. 4, the game participant Mr. Klick's personal information includes security access code 43, PIN 45, the game participants' name 47, and the game participant's e-mail address 49. Updated player information region 44 may also include a player instruction 48, which instructs the game participant to begin playing the game by making selections for the location of the winning object in game image 12.

Game site 10 validates unique access code 43 to provide,the game participant with access to the page containing game image 12 for placing a game entry. Use of unique access code 43 and PIN 45 also allows the game participant to register with the gaming authority to play the game through game site 10 and to collect a prize that he or she may win. Validation of access code 43 ensures that only an authorized game participant in possession of a ticket may play the game and place game entries.

In a preferred embodiment, the game participant's winning status may be confirmed automatically using the game participant's e-mail address 49. The prize may be awarded by wiring a cash prize to an account of the game participant, or by the game participant's appearance at a game agent or retail location to redeem the ticket for a cash prize.

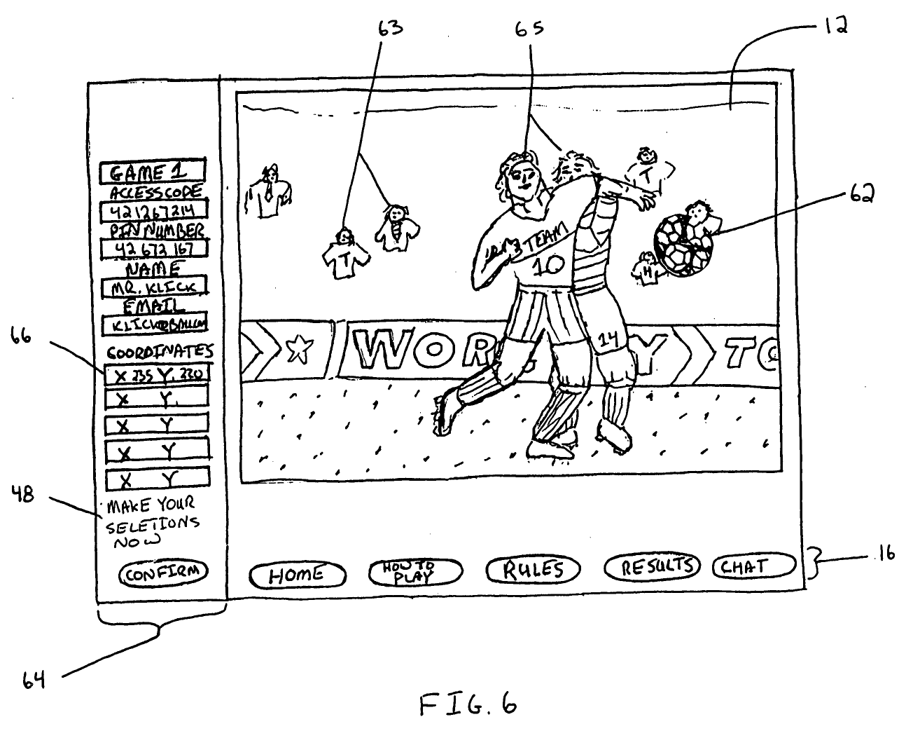

FIG. 6 shows game image 12 displayed on game site 10 in a play mode. To play the game, the game participant, Mr. Klick, attempts to determine, using skill and judgment, and selects the location of the winning object, a soccer ball, in the photograph making up game image 12. In particular, the game participants tries to determine the exact location of the center of the winning object on the coordinate system that underlies game image 12, which is unknown to the game participant, based on clues obtained from game image 12 itself.

The game participant selects a possible location for the winning object using a pointer 62, shown in the shape of a soccer ball, controlled by mouse 26. The game participant sees the winning object move on game image 12, and controls the movement of pointer 62 about image 12 using mouse 26. Preferably, the game participant drags mouse 26 to pointer 62 in a desired location and clicks a button on mouse 26 to select that location as a possible location for the winning object. The coordinates for the selected location, based on the underlying two-dimensional coordinate system, are stored as coordinates 66. In other embodiments, a game participant may be provided other controls, such as keys on keyboard 28 or a touch-sensitive screen for controlling the movement of pointer 62.

Game image 12 on game site 10 preferably contains clues indicative of a possible location of the winning object. For example, spectators 63 in the audience and the body language and facial expressions of soccer players 65 in game image 12 may suggest possible locations for the winning object. Also, in other games where the winning object may not be concealed, but the identity of which remains unknown to the game participants, game image 10 may provide visual, audio and factual clues as well to aid the game participant in his or her selections. In still other games, game participants may be able to compete directly against each other, the winner advancing until only one game participant remains.

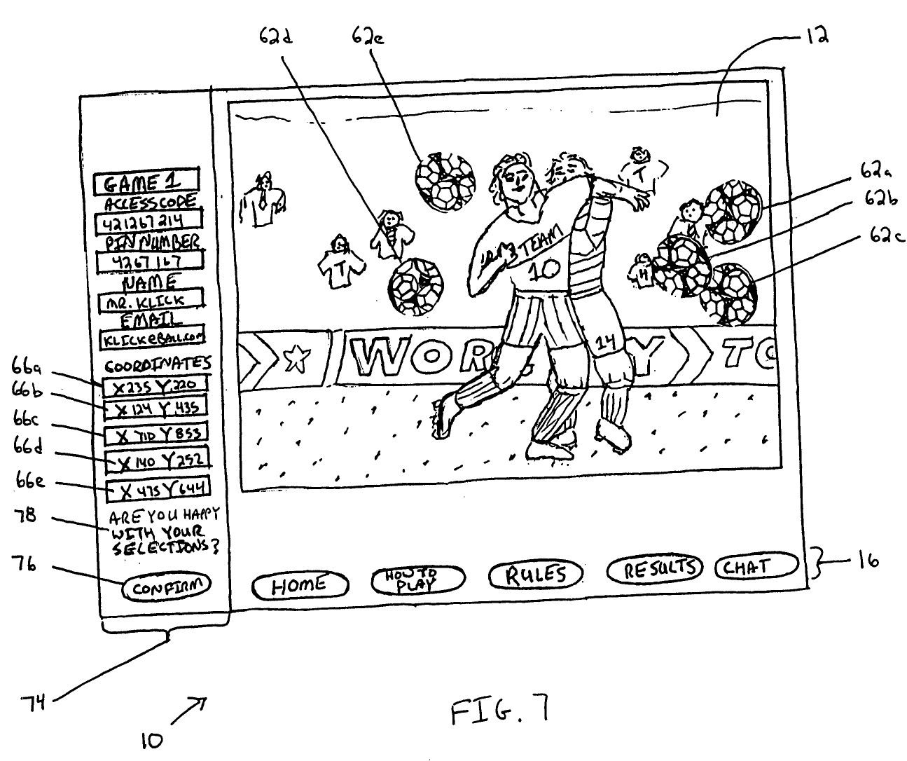

As shown in FIG. 6, game site 10 computes and stores the game participant's selected location for the winning object as coordinates 66 in updated player information region 64. The game participant then selects four more possible locations for the winning object (FIG.7) using the mouse click-drag-and-drop function.

FIG. 7 shows game image 12 updated with player information region 74 having the game participant's five selected possible locations 66a-e for the winning object. Game site instruction 78 asks the game participant whether he or she is satisfied with the selections for possible locations for the winning object. If the game participant is dissatisfied with his or her choices, the game participant may select one or more of pointers 62a-e and reposition the winning objects about image 12. Once the game participant is satisfied with the selections, he or she clicks confirm button 76 to submit the selected coordinates 66a-e for acceptance by game site 10. At the same time the access code and security number may be nullified from use for making further entries to the game. Alternatively, the player may be able to place additional game entries at another time using the same security information. Accepted coordinates 66a-e are recorded by game server 22 and may subsequently be used to determine whether game participant Mr. Klick has won the game. For example, in the Klickball™ game, the game participant will be declared a winner if one of his or her selections 66a-e matches the exact center of correct location of the winning object in the game image.

If several game participants have selected the correct position for the winning object then the prize may be distributed proportionally among the winners, or may be awarded to the game participant having the next closest selection. If no game participant correctly selects the winning object, the prize may be awarded to the game participant with the closest selection, or may be rolled over into a future game. Alternatively, the game may be played as a promotion for which there are no monetary prizes. In the case of a purely promotional game, game participants may be able to access the game site without any validation of security information, allowing game participants to simply play the game.

Game participants may keep track of their selections by recording them on ticket back 52 in coordinate region 57, e-mailing them to their e-mail accounts, or saving them on game participant computers 24. Nevertheless, game server 22 keeps track of all accepted selections and other pertinent gaming information. Game site 10 may also inform game participants if they are winners.

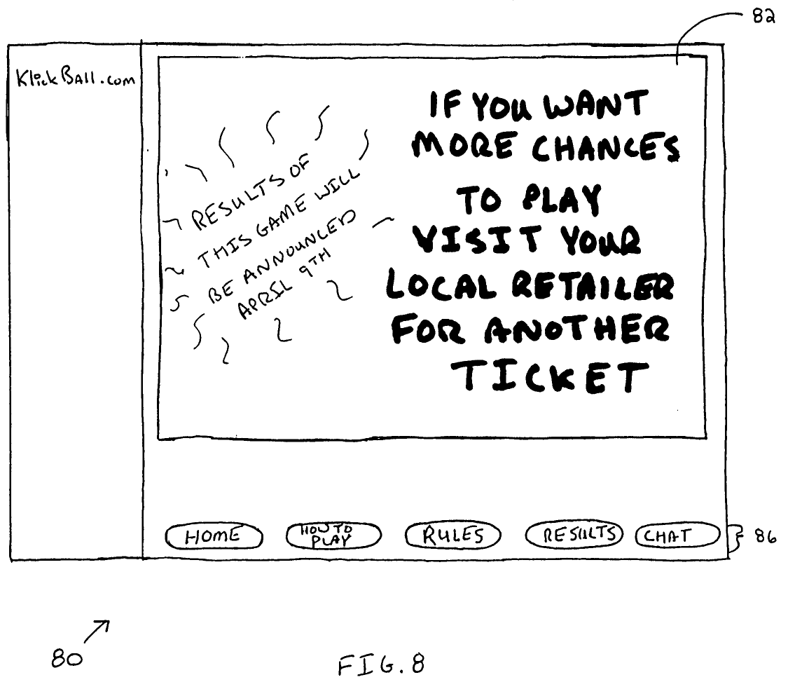

FIG. 8 shows an exit page 80 associated with game site 10 having gaming information 82 and exit links 86. Gaming information 82 informs game participants about the status of their selections and the outcome of the game. For example, gaming information 82 informs the game participant to check for results of the Klickball™ game at a certain time to see whether he or she is a winner. Exit links 86 may provide the game participant with information he or she may find helpful or interesting upon completion of the game.

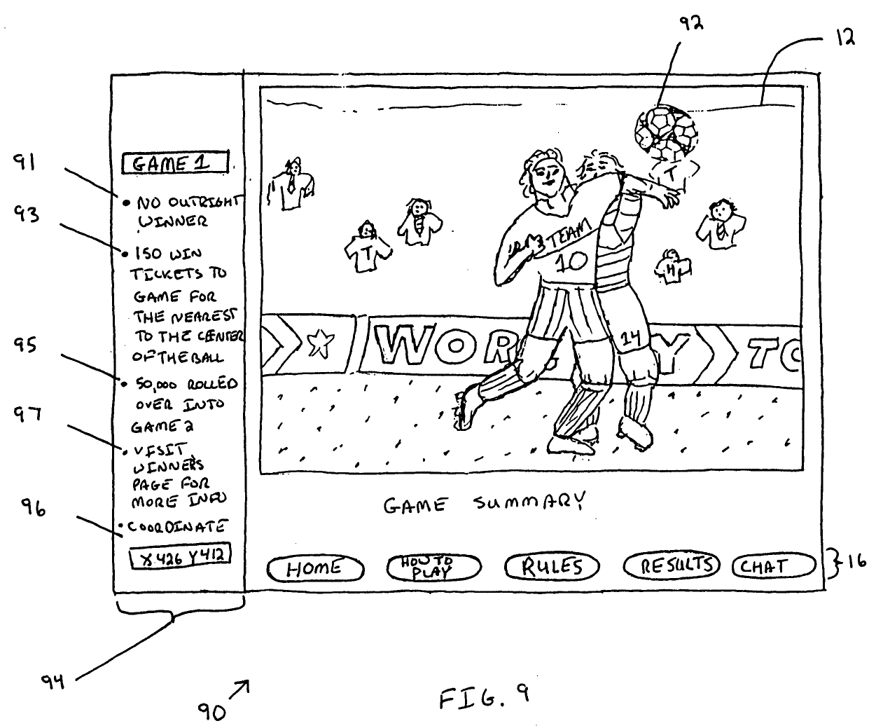

Award page 90, shown in FIG. 9, includes game image 12 revealing the correct location of winning object 92 and game summary information region 94. Award page 90 informs game participants of the outcomes of the game. For example, game image 12 reveals the previously concealed correct location of winning object 92 in the game image.

Game summary information 94 contains prize information pertaining to the particular game. In FIG. 9, e.g., the game summary information indicates that there was no outright winner 91, that several game participants won tickets to a soccer game for being nearest to the center of the ball 93, and the amount of money rolled over into the next game 95. Game summary information region 94 also provides the coordinates 96 of the correct location of the 10 center of winning object 92 in image 12 and provides a link 97 to visit a winners page for more details about the correct location of the winning object and redeeming the prizes.

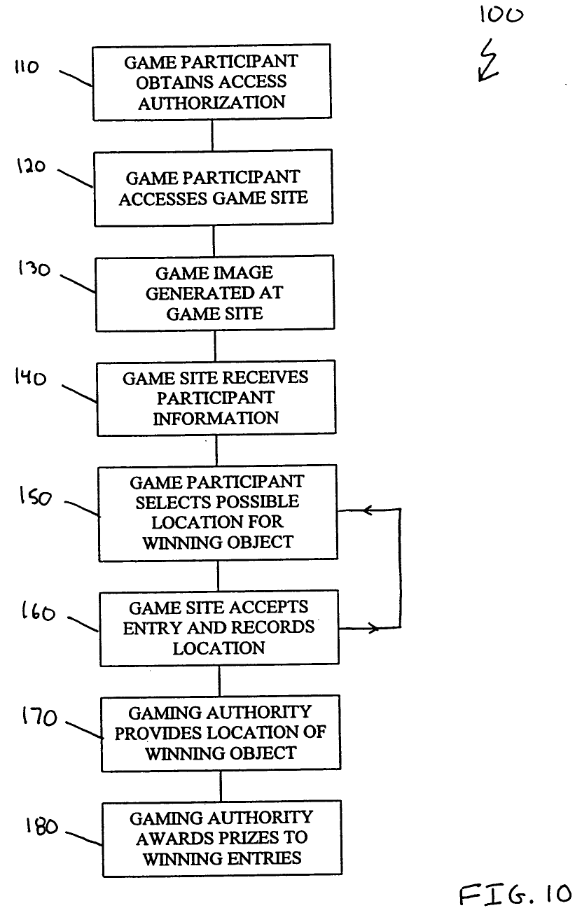

FIG. 10 is a flow diagram showing a method 100 for implementing the game of the present invention. A game participant obtains (110) a ticket to authorize him or her to play the game, e.g., from a point-of-sale terminal 5. The game participant accesses (120) a game site using game participant computer 24. Server 22 generates (130) a game image 12 at game site 10. The game site 10 receives (140) access information printed on the ticket to place game entries using game site 10. The game participant guesses the location of the winning object in game image 12 by moving the mouse attached to game participant computer 24 and selects (150) a possible location for winning object 92 by pressing a button on mouse 26.

The game site accepts (160) the entry and records the coordinates of the location for the winning object selected by the game participant. The game participant may then repeat the guessing and selecting steps to place additional entries as authorized according to the ticket.

At a predetermined time, the correct location of the winning object is provided (170) to the game participant to determine whether any of the entries that he or she placed were winning entries. The game participant may obtain this information by accessing the game site using game participant computer 24, via an e-mail message generated by server 22, or through other media such as a newspaper. The gaming authority, here run by server 22, 30 awards (180) prizes to those game entries that include selections of the correction location of the winning object in game image 12.

The game of the present invention may also be combined with advertising associated with the theme of the game, e.g., advertising for sporting events. Such advertising may be displayed to the game participants at game site 10 during play of the game.

A number of embodiments of the invention have been described. Nevertheless, it will be understood that various modifications may be made without departing from the spirit and scope of the invention. For example, other sporting events may be used for the game image. The game may also be adapted to any theme, such as finding the “magic” star in a photograph of a night sky, finding a winning light in a photograph of a Christmas tree, or finding a winning fish in a picture of an underwater school of fish. Accordingly, other embodiments are within the scope of the following claims.

1. A system for implementing a game played by a game participant, comprising:
a ticket having a security feature;
a server operating a game site including a game image; and
a game participant computer capable of accessing the game site over a network, the game participant entering the security feature at the game participant computer to play the game, including locating a winning object in the game image using the game participant computer.

2. The system according to claim 1 wherein the game participant computer further comprises a mouse for locating the winning object in the game image.

3. The system according to claim 1 wherein the image includes a coordinate system for determining the location of the winning object.

4. The system according to claim 1, further comprising
an on-line point-of-sale terminal for generating the ticket.

5. The system according to claim 4 wherein the on-line point-of-sale terminal is capable of communicating with the server.

6. The system according to claim 1 wherein the network is the Internet.

7. The system according to claim 1 wherein the ticket is a scratch ticket.

8. A method of implementing a game, comprising:
providing a game site for playing the game;
generating a game image on the game site and a coordinate system to define a location of a winning object in the game image;
accepting a selection of a location of the winning object in the game image; and
awarding a prize based on the selection of the location of the winning object compared to a correct location of the winning object in the game image.

9. The method of claim 8, further comprising
providing a security feature for accessing the game site.

10. The method of claim 9, further comprising
providing a ticket containing the security feature.

11. The method of claim 8 wherein the winning object is absent from the game image.

12. The method of claim 8, further comprising
generating a pointer in the game image; and
tracking a movement of the pointer in the game image based on a location of the pointer as defined by the coordinate system.

13. The method of claim 12, further comprising
accepting the selection for the location of the winning object based on the location of the pointer in the game image.

14. The method of claim 12, further comprising
displaying the pointer in the shape of the winning object.

15. The method of claim 8, further comprising
providing a clue to suggesting the location of the winning object.

16. The method of claim 15 wherein the clue is provided in the game image.

17. The method of-claim 8 wherein a plurality of selections for the location of the winning object are accepted.

18. The method of claim 17 wherein the prize is awarded based a one of the plurality of possible sections determined to be closest to the correct location of the winning object.

19. A method of implementing a game played by a game participant, comprising:
providing a game site for playing the game, the game site being accessible to the game participant over a network;
validating a security feature input at the game site, the security feature being provided to the game participant to play the game and to prevent an unauthorized access to the game site; and
generating the game upon validation of the security feature.

20. The method of claim 19, further comprising
providing an on-line point-of-sale terminal for generating a ticket, the ticket containing the security feature.

21. A system for implementing a game played by a game participant, comprising:
a ticket having a security feature;
a server operating a game site including a game image; and
a game participant computer capable of accessing the game site over a network, the game participant entering the security feature at the game participant computer to play the game.

22. The system of claim 20, further comprising an on-line point-of-sale terminal for generating the ticket.

23. An apparatus comprising a computer-readable medium that stores instructions for implementing a game played by a game participant, the instructions for causing a computer to:
provide a game site for playing the game;
generate a game image on the game site and a coordinate system to define a location of a winning object in the game image;
accept a selection of a location of the winning object in the game image; and
award a prize based on the selection of the location of the winning object compared to a correct location of the winning object in the game image.

24. The apparatus of claim 23, further comprising instructions for causing a computer to
provide a security feature for accessing the game site.

25. A system for implementing a game played by a game participant, comprising:
a memory which stores computer instructions; and
a processor that executes the computer instructions to:
provide a game site for playing the game;
generate a game image on the game site and a coordinate system to define a location of a winning object in the game image;
accept a selection of a location of the winning object in the game image; and
award a prize based on the selection of the location of the winning object compared to a correct location of the winning object in the game image.

26. The system of claim 25, further comprising instructions to
provide a security feature for accessing the game site.

27. An apparatus comprising a computer-readable medium that stores instructions for implementing a game played by a game participant, the instructions for causing a computer to:
provide a game site for playing the game, the game site being accessible to the game participant over a network;
validate a security feature input at the game site, the security feature being provided to the game participant to play the game and to prevent an unauthorized access to the game site; and
generate the game upon validation of the security feature.

28. The apparatus of claim 27 further comprising instructions for causing a computer to
generate a ticket for providing the security feature.

29. A system for implementing a game played by a game participant, comprising:
a memory which stores computer instructions; and
a processor that executes the computer instructions to:
provide a game site for playing the game, the game site being accessible to the game participant over a network;
validate a security feature input at the game site, the security feature being provided to the game participant to play the game and to prevent an unauthorized access to the game site; and
generate the game upon validation of the security feature.

30. The system of claim 29, further comprising
an on-line point-of-sale terminal for generating a ticket, the ticket containing the security feature.
